(19) United States
(12) Patent Application Publication
(10) Pub. No.: US 2026/0328695 A1
(43) Pub. Date: Oct. 22, 2026

(54) Optical Fiber pH Sensor with a Calcined Polymer Coating as the pH Sensing Layer

(71) Applicant: United States Department of Energy, Washington, DC (US)

(72) Inventors: Alexander Shumski, Pittsburgh, PA (US); Ruishu Feng Wright, Pittsburgh, PA (US); Daejin Kim, Pittsburgh, PA (US)

(21) Appl. No.: 19/633,090

(22) Filed: Mar. 30, 2026

Related U.S. Application Data
(60) Provisional application No. 63/779,608, filed on Mar. 28, 2025.

(51) Int. Cl. G01N 21/80; C03C 25/106; E21B 47/00; G01N 21/47; G01N 21/954; G02B 1/04

(52) U.S. Cl. CPC G01N 21/80; C03C 25/1061; G01N 21/474; G01N 21/954; G02B 1/048; C03C 2218/322; E21B 47/006; G01N 2021/4709; G01N 2021/4742; G01N 2021/9546; G01N 2201/088

(57) ABSTRACT

One or more embodiments relate to a method of forming an optical pH sensor and an optical pH sensor used in harsh conditions. Embodiments of the optical pH sensor include an optical fiber; and a calcined polymer coating contacting the optical fiber whereby the optical pH sensor provides real-time monitoring of pH in high-pressure and high-temperature (HPHT) conditions.

### CROSS-REFERENCE TO RELATED APPLICATIONS

This application claims the benefit of and priority to U.S. Provisional Patent Application Ser. No. 63/779,608 filed Mar. 28, 2025, the complete subject matter of which is incorporated herein.

### STATEMENT OF GOVERNMENT INTEREST

The United States Government has rights in this invention pursuant to the employer-employee relationship of the Government to the inventors as U.S. Department of Energy employees and site-support contractors at the National Energy Technology Laboratory.

### BACKGROUND OF THE INVENTION

Optimal control of pH is an important parameter in wellbores. Firstly, high-pressure gas storage wellbores are subject to the risk of leaks or blowouts as a result of structural damage to the casing structure. Corrosion is one of primary causes of damage to wellbore casing components and is a highly pH sensitive process due to the direct connection of aqueous acid concentrations to corrosion processes, with potentially massive consequences for public safety and site operators. As the wellbore regions subject to corrosion can be hundreds to thousands of feet below the surface at elevated pressures and geological heating, a robust and long-distance sensor is necessary to monitor for changes in a variety of wellbore conditions (Table 1).

TABLE 1
List of Common Wellbore Conditions across energy storage and extraction applications.

| | | Average | | | | pH | Dissolved | Common |
|---|---|---|---|---|---|---|---|---|
| Application | Depth | Temperature | | Pressure | | Range | Solvents | Ions |
| CO₂ Storage | 200- | 25-100 | °C | 5-35 | MPa | 3-6 | 10,000- | Sulfides, |
| | 2000 m | | | | | | 70,000 mg/L | CO₂/Carbonate, |
| | | | | | | | | Cl⁻, Na⁺, K⁺, |
| | | | | | | | | H₃O⁺, Ca²⁺ |
| | | | | | | | | Mg²⁺, Ba²⁺, Sr²⁺, |
| | | | | | | | | Fe^{II/III} |
| H₂ and | 200- | 25-100 | °C | 5-30 | Pa | 4-9.5 | 10,000- | Sulfides, |
| H₂/CH₄ Blend | 2000 m | | | | | | 70,000 mg/L | CO₂/Carbonate, |
| Storage | | | | | | | | Cl⁻, Na⁺, K⁺, |
| | | | | | | | | H₃O⁺, Ca²⁺, |
| | | | | | | | | Mg²⁺, Ba²⁺, Sr²⁺ |
| | | | | | | | | Fe^{II/III} |
| Geothermal | 3000- | >90 | °C** | ~30- | | Most 5-9, | 2000- | Sulfides, |
| | 4000 m | 150-300 | °C | 50 MPa | | acidic 2.5-4 | 50,000 mg/L | CO₂/Carbonate, |
| | | | | | | | | NO₃, Cl⁻, Na⁺, |
| | | | | | | | | K⁺, Ca²⁺, Mg²⁺, |
| | | | | | | | | Ba²⁺, Sr²⁺ |
| Oil/Natural | 1000- | <150 | °C*** | <70 | MPa*** | 3-9.5 | 10,000- | Sulfides, SO₄², |
| Gas | 10,000 m | | | | | | 200,000 mg/L | CO₂/Carbonate, |
| | | | | | | | | Cl⁻, Na⁺, K⁺, |
| | | | | | | | | H₃O⁺, Ca²⁺, |
| | | | | | | | | Mg²⁺, Ba²⁺, Sr²⁺ |
| | | | | | | | | Fe^{II/III} |

* On average, pH range is highly dependent on local geography
**For certain low temperature coupled layouts
***Some HPHT wells are potentially much higher

Additionally, downhole pH measurements provide insight into subsurface geochemistry and can inform and validate geochemical and geomechanical models of the wellbores to understand the evolution of subsurface conditions and gas storage efficacy. However, current wellbore sensing suites lack reliable technologies for in situ, real-time pH subsurface monitoring due to harsh environmental conditions. The existing approach for wellbore pH sensing usually involves either inserting wireline pH probe systems or withdrawing periodic samples of wellbore fluid. Fluid sampling poses a variety of issues due to pressure and temperature related equilibrium shifts when brought to the surface, requiring specialized modeling to accurately describe wellbore conditions. Wireline systems, while very capable of gathering high quality data, are usually part of expensive monitoring suites and only provide information at the location of the probe, which is lowered and raised in the well during deployment. Common monitoring suites are also highly focused on pressure and temperature due to safety and efficiency concerns, with pH as a secondary concern. Hence, there is a technology gap in subsurface in-situ pH sensing.

For natural gas and hydrogen storage wells, the pH sensor must also be safe around highly flammable gas. Existing sensors are currently designed as point sensors, which only allows for monitoring pH at pre-determined or actively controlled locations through wireline probes. Comparatively, it is more advantageous to have a passive distributed sensing system that provides continuous information throughout the wellbore. A summary of the limitations of existing sensors is presented in Table 2 below.

TABLE 2
Summary of current pH sensor designs, including
pH range, advantages and disadvantages.

| | | pH | | |
|---|---|---|---|---|
| Sensor Type | Sensing Mechanism | Range | Advantages | Disadvantages |
| Glass pH Probes | Electrochemical potential | 0-14 | High | Low |
| | | | reliability | durability |
| | | | Wide | Not |
| | | | range | designed for |
| | | | low cost | non-ambient |
| | | | | conditions |
| | | | | Ion cross- |
| | | | | sensitivity |
| Ceramic | Electrochemical potential | 0-14 | High | Moderately |
| Membrane pH | | | reliability | expensive |
| Probe | | | Wide | Better at |
| | | | range | high |
| | | | Durable | temperatures |
| | | | | point sensor |
| | | | | only |
| Ion Sensitive Field | Field effect transistor | 1-13 | Small size | Difficult to |
| Effect Transistor | conductivity | | High | manufacture |
| (ISFET) | | | stability | Heat |
| | | | Low ion | sensitive |
| | | | cross | |
| | | | sensitivity | |
| Microlab and | Electrochemical potential | 2.5-9 | Small size | Not |
| Microfluidic | Field effect transistor | | Good for | optimized for |
| | conductivity | | sensor | high |
| | Optical channels | | arrays | temperatures |
| | | | High | Low relative |
| | | | pressure | stability |
| | | | compatible | Primarily |
| | | | | point sensors |
| Optical Fiber | Evanescent waves | 0-14 | Low-cost | Decreased |
| Sensors | Optical coating response | | sensor | response |
| (Evanescent) | Refractive index or | | components | relative to |
| | absorbance | | Safe in a | transmission |
| | | | flammable | cell |
| | | | environment | Strong |
| | | | Long range | coating |
| | | | | dependence |
| | | | | Hardware |
| | | | | can be |
| | | | | expensive |
| | | | | Point |
| | | | | sensing |
| Optical Fiber | Interferometric | 2-12 | Can be | Expensive |
| Sensors | wavelength shift | | designed | hardware |
| (Interferometry) | Strain changes | | with low- | Certain fiber |
| | | | cost sensor | designs are |
| | | | components | expensive |
| | | | Distributed | Decreased |
| | | | sensing | resolution at |
| | | | Long range | extended |
| | | | Strain or | ranges |
| | | | amplitude | Limited |
| | | | | operational |
| | | | | wavelengths |
| | | | | Strain |
| | | | | sensors are |
| | | | | pressure and |
| | | | | temperature- |
| | | | | dependent |
| Acoustic Wave | Electronic conductivity | 2-12 | Versatile | Cross |
| | Surface acoustic waves | | Small size | sensitivity to |
| | Magnetoelastic response | | Wireless | temperature |
| | | | Can be | and pressure |
| | | | designed | Can be |
| | | | for | vulnerable to |
| | | | flammable | corrosion |
| | | | environments | Point sensors |

Because subsurface pH monitoring is important for wellbore integrity and geochemical monitoring, it primarily affects wellbore operations. The impacted entities include wellbore owners, operators, service companies, regulators, and sensor manufacturers.

Optical fiber sensors are an emerging technology and have advantages of chemical stability, spatially distributive measurements, long reach, small size, flexibility, geometric versatility, light weight, multiple-parameter sensing, inherent immunity to electromagnetic interference (EMI), compatibility with harsh environments, compatibility to optical fiber data communication systems, and improved safety in the presence of flammable gases compared to electrical based sensors. Distributed physical sensing such as distributed temperature (DTS), strain (DSS), and acoustic sensing (DAS) have showed promising potential in wellbore monitoring, but distributed chemical sensing is less mature. Functional sensing materials is the key enabling component to achieve optical fiber chemical sensing, for both point and distributed sensors. The key performance requirements for subsurface monitoring are to endure HTHP harsh environments with long-term stability and compatible with storage gas, for example, flammable gas hydrogen or hyblend storage wells. A need exists for a pH sensor that provides disruptive technology to enable in-situ real-time monitoring of pH in subsurface.

### SUMMARY OF THE INVENTION

One object of at least one embodiment is related to an optical fiber pH sensor functionalized with a calcined polymer coating for in-situ pH monitoring in high pressure and high temperature (HPHT) wellbore conditions that are applicable for subsurface monitoring such as production wells, enhanced oil recovery (EOR) wells, and hydrogen storage wells. Embodiments include a coating that is easy to synthesize and enables both acid and basic pH sensing range at HPHT. As the optical fiber design is compatible with optical backscattering reflectometry (OBR) methods, the sensor coating enables spatially resolved distributed sensing along the entire well.

Additionally, embodiments provide geochemists with greater visibility into subsurface geochemistry in real time. The wellbore applications may include production wells, H2 storage wells, EOR wells, geothermal wells, geologic H2 wells, and water wells. Other potential applications include oil and gas pipelines, where pH can be used to monitor the effectiveness of corrosion inhibitors along the pipeline, and distributed, long-distance, optical fiber-based pH sensors have unique advantages.

One or more embodiments relates to an optical pH sensor used in harsh conditions. Embodiments of the optical pH sensor include an optical fiber; and a calcined polymer coating contacting the optical fiber whereby the optical pH sensor provides real-time monitoring of pH in high-pressure and high-temperature (HPHT) conditions.

Still other embodiments relate to a sensing system that includes an optical pH sensor used in harsh conditions. Embodiments of the optical pH sensor include a optical fiber; and a calcined polymer coating contacting the optical fiber whereby the sensing system provides real-time monitoring of pH in high-pressure and high-temperature (HPHT) conditions.

Yet other embodiments relate to a method of forming an optical fiber pH sensor. Embodiments include applying a nitrogen-containing polymer solution to an optical fiber, forming a coated fiber; and calcinating the coated fiber forming the optical fiber pH sensor.

In any of the embodiments, the optical fiber is selected from a group including unjacketed coreless optical fibers, unjacketed tapered multi-mode fibers, unjacketed single-mode fibers, and/or other evanescent-field optical fibers. Embodiments include the calcinated polymer coating that is about 100 nm to about 3 μm thick, operated in HPHT conditions including pressures of up to about 1500 psi and temperatures up to about 80° C., and/or is able to monitor pH levels ranging between 2 and 12. In at least one embodiment, an exemplary embodiment of the calcinated polymer coating is an oxidized, water-insoluble coating, which is about 100 nm to about 3 μm thick.

Embodiments of the sensing system includes a point sensor system layout and/or a distributed sensor system layout. Exemplary embodiments of the point sensor system include the optical pH sensor that communicates with at least two multi-mode fibers for transmission measurements and/or communicates with at least one multi-mode fiber for reflection measurements. Exemplary embodiments of the distributed sensing system include the optical pH sensor that communicates with at least one single-mode fiber, wherein the optical pH sensor is interrogated with an optical backscatter reflectometer.

Embodiment of the method of forming an optical pH sensor includes a nitrogen-containing polymer solution comprising a 10-30% by weight nitrogen-containing polymer in an organic solvent. Embodiments include the nitrogen-containing polymer solution comprises an organic polymer containing a nitrogen-based functional group, wherein the nitrogen-based functional group is selected from the group consisting of polymeric amines, polymeric amides, polyimides, and combinations thereof; wherein polymeric amines are selected from the group consisting of polyethylenimine, polyaniline, and combinations thereof; the polymeric amides are selected from the group consisting of polyvinylpyrrolidone, nylon, and combinations thereof; and/or the polyimides are selected from the group consisting of poly-(4,4′-oxydiphenylene), pyromellitimide, and combinations thereof. One exemplary embodiment includes calcinating the coated, coreless fiber by thermally treating it for about 2 hours at about 400-500° C.

### BRIEF DESCRIPTION OF DRAWINGS

Still another embodiment relates to a method of forming an optical fiber pH sensor. The method includes applying a polyethylenimine solution to a coreless optical fiber, forming a coated, coreless fiber; and calcinating the coated, coreless fiber forming the optical fiber pH sensor.

The invention together with the above and other objects and advantages will be best understood from the following detailed description of the preferred embodiment of the invention shown in the accompanying drawings, wherein:

FIG. 1 depicts a schematic representation of a pH-sensor;

FIG. 2 depicts a schematic representation illustrating a method for preparing a pH-sensor coating on a representative bare, coreless optical fiber section;

FIG. 3 depicts a schematic representation of an exemplary layout of an optical fiber pH sensor when operated as a transmission-based point sensor;

FIG. 4 depicts a schematic representation of an optical fiber pH sensor operating as a distributed sensor;

FIGS. 5A-5B depict graphs illustrating the transmission response of the invention at 80° C. at ambient pressure in a 0.1M citrate buffer solution at pH 3-11;

FIGS. 6A-6B depict graphs illustrating distributed sensing response at 80° C. at ambient pressure in a 0.1M citrate buffer solution at pH 3-10;

FIG. 7 depicts a schematic of a reactor and measurement setup used in transmission experiments;

FIG. 8 depicts a schematic of a reactor and measurement setup used in distributed sensing OBR experiments, where the OBR was connected to the SMF by splicing to an SMF patch cord;

FIGS. 9A-9B depict graphs illustrating transmission response at 600 nm of the invention at 20° C. at ambient pressure in a 0.1 M citrate buffer solution at pH 3-11 where FIG. 9A illustrates raw data normalized to pH 3.67 while FIG. 9B depicts extracted data for individual pH measurements normalized to pH 3.67, with the blue data points corresponding to increasing pH and the orange points corresponding to a subsequent decreasing pH hysteresis test demonstrating reversibility;

FIGS. 10A-10B depict graphs illustrating high pressure pH testing using the same transmission methodology as ambient pressure tests at 80° C. and up to 1050 psig, with pressurized conditions shown in red and dotted lines marking when base was added to the system where the system was depressurized and opened in order to titrate in additional base solution and measure the altered pH;

FIGS. 11A-11F depict SEM of calcined PEI coated fiber as prepared (FIGS. 11A-11C) and after 3 days in DI water 800 psi of CH4 pressure at 80° C. (FIGS. 11D-11F);

FIG. 12 depicts a graph illustrating repeat pH sensing at ambient pressure and 80° C. after the fiber was previously tested in a pressurized condition at 80° C.; and

FIG. 13 depicts a table providing a summary of ecosystem and value chain for pH sensors.

### DETAILED DESCRIPTION OF THE INVENTION

The foregoing summary, as well as the following detailed description of certain embodiments of the present invention, will be better understood when read in conjunction with the appended drawings.

The following detailed description should be read with reference to the drawings in which similar elements in different drawings are numbered the same. The drawings, which are not necessarily to scale, depict illustrative embodiments and are not intended to limit the scope of the invention.

One or more embodiments relate to a pH sensor that provides disruptive technology for in situ, real-time monitoring of pH under subsurface conditions. Embodiments may provide geochemists with greater visibility into subsurface geochemistry in real time. Wellbore applications may include production wells, H2 storage wells, EOR wells, geothermal wells, geologic H2 wells, and water wells. Embodiments may be used in oil and gas pipelines, where pH can be used to monitor the effectiveness of corrosion inhibitor along the pipeline, where the distributed long-distance optical fiber-based pH sensor has unique advantages.

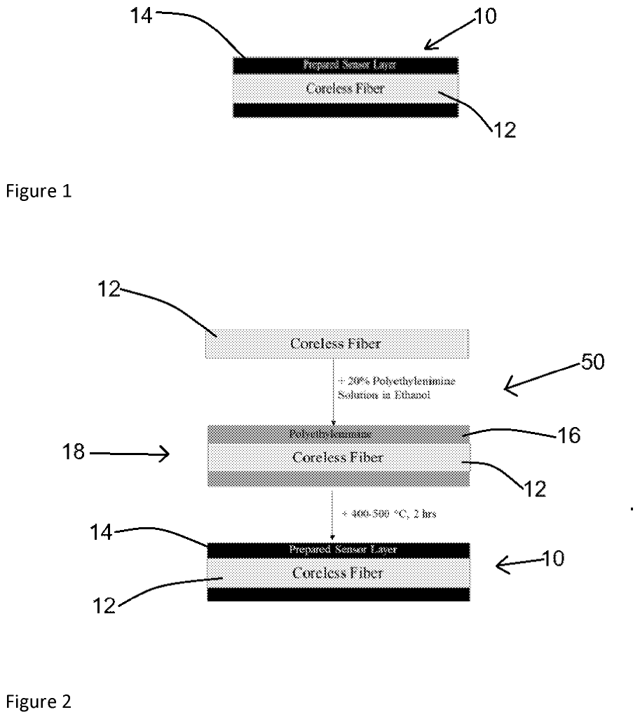

FIG. 1 depicts a schematic representation of an optical pH-sensor 10 in accordance with one embodiment used in harsh conditions. One or more embodiments relates to an optical fiber 12 functionalized with a calcined polymer coating 14 for a wide range of pH monitoring in harsh wellbore conditions. Embodiments are based on optical fiber evanescent-field sensing to detect changes in the coating's refractive index upon exposure to solutions with varying pH or hydronium ion (H₃O+) concentrations.

In at least one embodiment, the fiber 12 is selected from a group comprising unjacketed coreless optical fibers, unjacketed tapered multi-mode fibers, unjacketed single-mode fibers, and/or other evanescent-field optical fibers. Embodiments include the calcinated polymer coating that is about 100 nm to about 3 μm thick. The pH sensor 10 may operate under HPHT conditions, including pressures up to about 1500 psi and temperatures up to about 80° C., and/or monitor pH levels ranging from 2 to 12. In at least one embodiment, the calcinated polymer coating 14 is an oxidized, water-insoluble coating about 100 nm to about 3 μm thick.

FIG. 2 depicts a schematic representation illustrating a method 50 for preparing a pH-sensor 10 with a coating 14 on a representative bare, coreless optical fiber section 12. One or more embodiments relate to an optical fiber pH sensor 10 functionalized with a calcined polymer coating 14 for a wide range of pH monitoring in harsh wellbore conditions. Embodiments are based on optical fiber evanescent-field sensing to detect changes in the coating's refractive index upon exposure to solutions with varying pH or hydronium ion (H₃O+) concentrations.

One or more embodiments comprise an optical fiber pH sensor 10 functionalized with a calcined polymer coating 14 for a wide range of pH monitoring in harsh wellbore conditions. The pH sensitive coating 14 is prepared via application of a 20% ethanol/water solution of polyethylenimine coating 18, for example, onto a coreless optical fiber 12 followed by calcination, with a thickness of 100s of nm to several microns.

More specifically, method 50 of forming the optical fiber pH sensor 10 includes applying a nitrogen-containing polymer solution to the fiber 12, forming a coated fiber 18; and calcinating the coated fiber forming the optical fiber pH sensor. Embodiment of the method of forming an optical pH sensor includes a nitrogen-containing polymer solution comprising a 10-30% by weight nitrogen-containing polymer in an organic solvent. Embodiments include the nitrogen-containing polymer solution comprises an organic polymer containing a nitrogen-based functional group, wherein the nitrogen-based functional group is selected from the group consisting of polymeric amines, polymeric amides, polyimides, and combinations thereof; wherein polymeric amines are selected from the group consisting of polyethylenimine, polyaniline, and combinations thereof; the polymeric amides are selected from the group consisting of polyvinylpyrrolidone, nylon, and combinations thereof; and/or the polyimides are selected from the group consisting of poly-(4,4′-oxydiphenylene), pyromellitimide, and combinations thereof. One exemplary embodiment includes calcinating the coated, coreless fiber by thermally treating it for about 2 hours at about 400-500° C.

One or more embodiments include treating fiber 12 with heat and acid/base prior to calibration to stabilize coating properties. Embodiments include compensating for drift or minimizing sensor drift over long durations in HPHT conditions. Optimized coating thickness and calcination time for consistent and fast response to pH changes, and/or optimized length of coated sections for distributed and point sensor response are also considered.

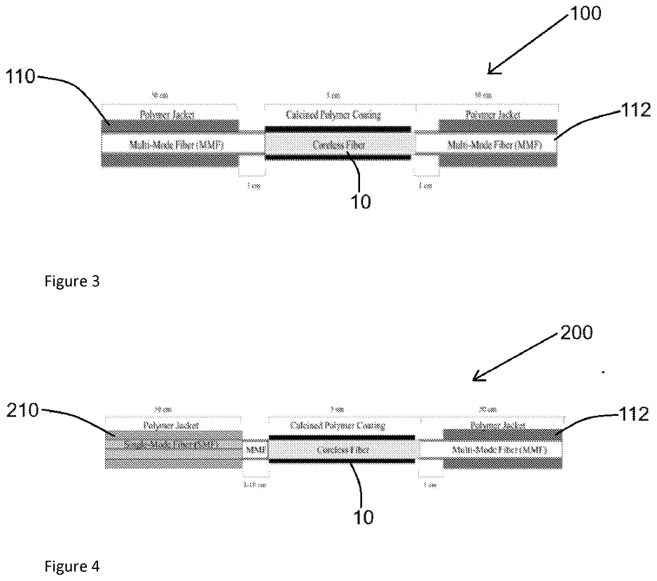

Embodiments of the fiber optic design make it compatible with at least two sensor layouts: a point sensor system 100 and/or a distributed sensor system 200. The point sensor system 100 is useful for applications where specific points of interest need to be monitored, while the distributed one is used for comprehensive monitoring across the entire length of the system. Both designs allow for continuous long-term monitoring of pH conditions. In at least one embodiment, the point sensor system 100 is prepared by splicing the coated section of coreless fiber between at least two multimode fibers 110 and 112, supplying a light source to one end and a spectrometer or detector to the other, and measuring transmission changes in response to pH changes. See FIG. 3, which depicts a schematic representation of an exemplary layout of an optical fiber pH sensor 10 when operated as a transmission-based point sensor, including the fiber length used in experimental tests and proof of concept, where, in practice, the multimode length can be extended substantially with low to moderate signal loss. As a distributed sensor, the multimode fiber is replaced with a single-mode fiber at the leading end, which is connected to an optical backscatter reflectometry (OBR) system for distributed backscattering measurements.

See FIG. 4, which depicts a schematic of an optical fiber pH sensor operating as a distributed sensor system 200, in which the single-mode lead-in fiber 210, directly connected to the OBR system, can be extended to extremely long ranges (km) with low attenuation. The multimode fiber connection from the single-mode fiber is not necessary for sensor response, but may reduce some of the splice loss due to core mismatch. The light sources, detector/spectrometer, and OBR systems are currently available commercially and can be interchanged with any appropriate system for the desired distance.

More specifically, embodiments of the sensing system includes a point sensor system 100 layout and/or a distributed sensor system 200 layout. Exemplary embodiments of the point sensor system include the optical pH sensor that communicates with at least two multi-mode fibers for transmission measurements and/or communicates with at least one multi-mode fiber for reflection measurements. Exemplary embodiments of the distributed sensing system include the optical pH sensor that communicates with at least one single-mode fiber, wherein the optical pH sensor is interrogated with an optical backscatter reflectometer.

In any of the embodiments, the optical fiber is selected from a group including unjacketed coreless optical fibers, unjacketed tapered multi-mode fibers, unjacketed single-mode fibers, and/or other evanescent-field optical fibers. Embodiments include the calcinated polymer coating that is about 100 nm to about 3 μm thick, operated in HPHT conditions including pressures of up to about 1500 psi and temperatures up to about 80° C., and/or is able to monitor pH levels ranging between 2 and 12. In at least one embodiment, an exemplary embodiment of the calcinated polymer coating is an oxidized, water-insoluble coating, which is about 100 nm to about 3 μm thick.

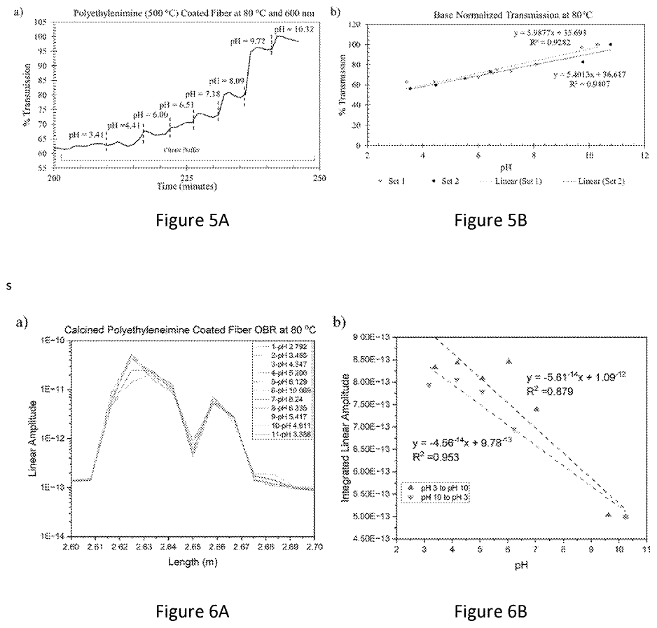

FIGS. 5A and 5B depict graphs illustrating the transmission response of one embodiment of the invention at 80° C. at ambient pressure in a 0.1M citrate buffer solution at pH 3-11. The pH range is slightly narrowed relative to room temperature due to high-temperature pKw changes. Raw data is shown in FIG. 5A and are normalized to pH 10.32. Extracted data for individual pH measurements, normalized to the maximum transmission at pH 10.32, are shown in FIG. 5B, with orange data points corresponding to increasing pH and black points to subsequent decreases, demonstrating hysteresis and reversibility.

FIGS. 6A and 6B depict graphs illustrating distributed sensing response at 80° C. at ambient pressure in a 0.1M citrate buffer solution at pH 3-10. As with the transmission test, the expected pH range is slightly narrowed at room temperature due to changes in pKw at high temperatures. The raw linear amplitude shown in FIG. 6A and the processed integrated linear amplitude shown in FIG. 6. The integrated linear amplitude is obtained by integrating over 2.61-2.675m, with a baseline of approximately 1E-13.

$$int . \vert \text{?} \vert = {\int }_{x 0}^{x 1} f ( x ) dx = m ( pH ) + b \qquad FORMULA 1$$

$$int . \vert \text{?} \vert = - {5.61}^{- 14} * pH + 1.09 * {10}^{- 12} from pH 3 to 10$$

Formula 1 is a peak integration formula for integrated linear amplitude (int. | [symbol] |) measurements, where x0 is the start of the sensor region, x1 is the end of the sensor region, and f(x) is the empirically measured function representing the linear amplitude across the sensor region. This value also correlates with a linear formula, with a pH response following an empirically determined response slope in units of integrated linear amplitude/pH (m) and integrated linear amplitude at pH 0 (b), allowing for the generation of a linear pH calibration plot from integrated linear amplitude values. This integration was performed using Originlab software across the entire coated sensor region using inbuilt peak fitting software and automatic 2^{nd} derivative baseline correction using linear interpolation. The second formula shows an example of the formula taken from FIG. 6B.

Amp[dB]ⱼ=10*log[| [symbol] |]

| [symbol] |=10^{(Amp[dB]}^{ⱼ}^{/10} FORMULA 2

Formula 2 shows an intensity-based linear amplitude (| [symbol] |)♦ or linear scale impulse) relationship to the logarithmic time domain amplitude (Amp[dB]ⱼ) that is collected by the OBR instrument.

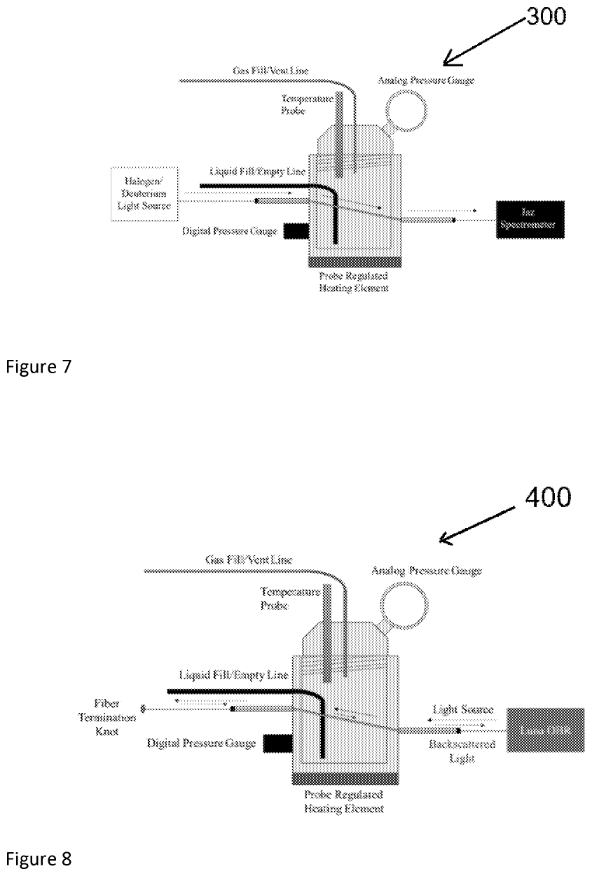

FIG. 7 depicts a schematic of a reactor and measurement setup 300 used in transmission experiments. FIG. 8 depicts a schematic of a reactor and measurement setup 400 used in distributed sensing OBR experiments, where the OBR was connected to the SMF by splicing to an SMF patch cord.

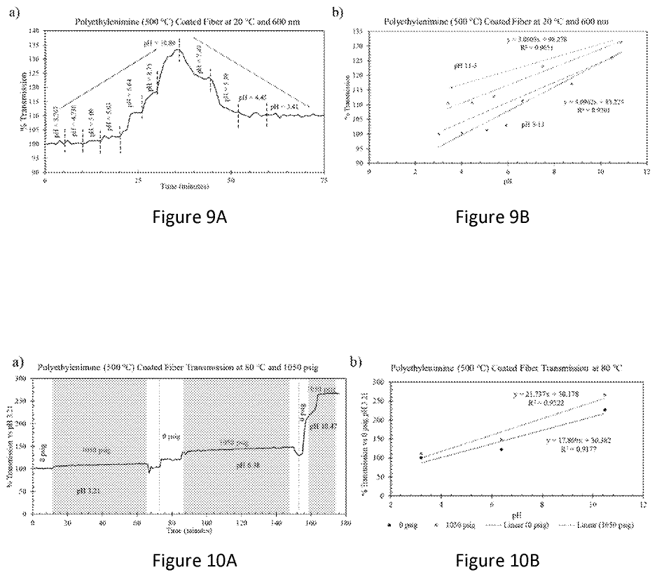

FIGS. 9A-9B depict graphs illustrating transmission response at 600 nm of the invention at 20° C. at ambient pressure in a 0.1 M citrate buffer solution at pH 3-11 where FIG. 9A illustrates raw data normalized to pH 3.67 while FIG. 9B depicts extracted data for individual pH measurements normalized to pH 3.67, with the blue data points corresponding to increasing pH and the orange points corresponding to a subsequent decreasing pH hysteresis test demonstrating reversibility.

For high pressure tests at 900-1050 psig, the sensor was loaded into a reactor from pH 3-11 in a manner similar to the ambient pressure testing (FIGS. 10A-10B). The system was depressurized and opened between test conditions before the addition of 1M NaOH titrant. The pressurized conditions are shown in the red highlighted region in FIG. 10A. Comparing the response at 0 psig and at 1050 psig (FIG. 10B) shows only a 10-20% increase in transmission when pressurized relative to ambient pressure conditions at the same pH and 80° C. This demonstrates the retention of sensitivity to pH at high pressure, with pressure not strongly impacting the sensor performance even at 80° C.

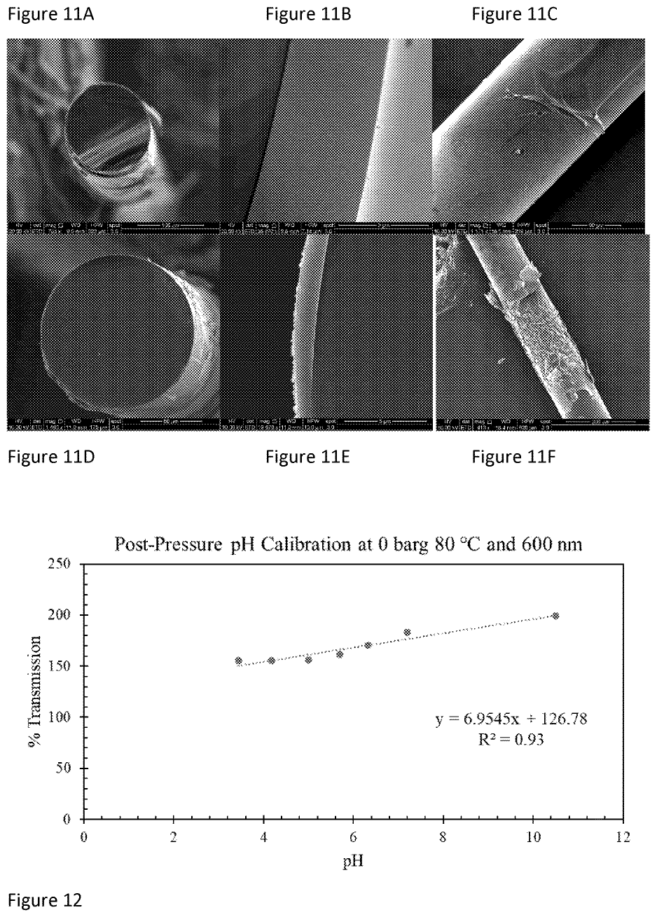

SEM was performed on the calcined PEI coating after 2 hours of 500° C. calcination. FIGS. 11A-11F depict SEM of calcined PEI coated fiber as prepared (FIGS. 11A-11C) and after 3 days in DI water 800 psi of CH4 pressure at 80° C. (FIGS. 11D-11F). As shown in the SEM in FIGS. 11A-11F, the coating is roughly between 1-3 μm thick, with certain regions (around 20-30% of coating coverage) developing a thicker wrinkled pattern up to 3-5 μm thick on curing at high temperature, potentially originating from the polymer's intramolecular interactions from N—H hydrogen bonding.

As illustrated, the thicker wrinkled regions are usually around 200-300 μm long and occur periodically along the entire length of coated fiber, which appears to correspond with visible beading that occurs during the coating process and prior to calcination. This pattern is retained after high-pressure and temperature exposure and does not appear to have a detrimental impact on sensor performance. A small amount of cracking can usually be observed in the calcined fiber prior to testing in some of the thicker regions, but the majority of the coating is usually relatively smooth and well attached to the fiber. The high-pressure exposure had a small impact on the physical properties of the coating by introducing additional cracking, as shown in FIGS. 11A-11F. As shown, the cracking didn't impact the sensor functionality. Coatings prepared with more concentrated polymer solutions (50% in water) develop much larger, more severely cracked or split spherical or knotted beads of wrinkled polymer with less consistent sensing properties and should be avoided.

FIG. 12 depicts a graph illustrating repeat pH sensing at ambient pressure and 80° C. after the fiber was previously tested in a pressurized condition at 80° C.; and

It should be appreciated that endowments of the sensor 10 could be integrated with a deployment system for insertion into pre-existing pressurized wellbores. Automated collection and readout of pH values from the system, with an alarm for abnormal readings, could be included. Improved packaging for mechanical stability is also contemplated. Embodiments may include the wireless transmission of data to a central system for monitoring multiple wells across a field and/or a combination with other chemical and physical sensors (i.e., temperature, pressure, vibration) into a single sensor cable. Exemplary embodiments may include solar-powered and/or rechargeable/replaceable battery for remote operation.

As pH sensing is useful in many contexts, the sensor coating may be usable in high pressure environments outside of the energy sector or environments where long range detection would be helpful. Possible options could include soil pH monitoring for agricultural applications, oceanic pH monitoring, detection of acidic runoff alongside rivers. As the fiber can be readily buried or submerged in water, it should be compatible with most applications that require pH measurements and involve water contact.

The sensor 10 may be integrated with a drill for deployment during drilling or fracturing, since drilling and fracturing fluids contain pH-control agents.

Deployment for buried gas or water pipeline monitoring at less intense temperature/pressure. Runoff monitoring for aquifers, rivers, lakes, and streams near industrial and mining sites. Oceanic pH monitoring lines. Agricultural soil pH monitoring systems.

The energy infrastructure ecosystem is currently developing to be more intelligent and digitalized, which needs real-time monitoring of the systems. One major group of users for pH sensor technology would be energy companies, represented primarily by existing extractors and transporters. Hypothetical replacement of depleted extraction wellbores with gas storage wells has been proposed, which would directly convert existing orphaned, abandoned or soon to be decommissioned wells back into active energy infrastructure.

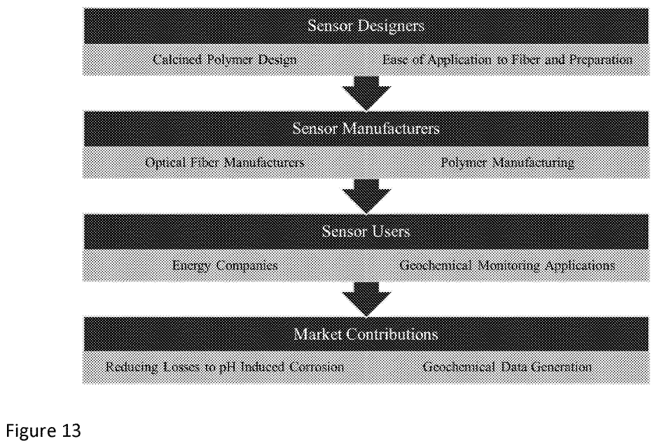

A summary of potential beneficiaries of the pH sensor patent are described in FIG. 13. The sensor design will hopefully provide sensor designers with a basis for further development of pH sensor technology using the pH sensor coating. Manufacturers will then be capable of producing sensors, with optical fiber and polymer manufacturers providing the sensor materials and preparing them for use. Prepared sensors will then be available to energy suppliers and transporters, as well as be available for other geochemical pH monitoring applications. Deployed sensors will then provide the benefit of helping to reduce asset losses from pH induced corrosion, and generate geochemical pH data.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. An optical pH sensor used in harsh conditions, the optical pH sensor comprising:
an optical fiber; and
a calcined polymer coating contacting the optical fiber whereby the optical pH sensor provides real-time monitoring of pH in high-pressure and high-temperature (HPHT) conditions.

2. The optical pH sensor of claim 1, wherein the optical fiber is selected from the group consisting of unjacketed coreless optical fibers, unjacketed tapered multi-mode fibers, unjacketed single-mode fibers, and other evanescent field optical fibers.

3. The optical pH sensor of claim 1, wherein the calcinated polymer coating is an oxidized, water-insoluble coating.

4. The optical pH sensor of claim 1, wherein the calcinated polymer coating is about 100 nm to about 3 μm thick.

5. The optical pH sensor of claim 1, wherein the HPHT conditions include pressures of up to about 1500 psi and temperatures up to about 80° C.

6. The optical pH sensor fiber of claim 5, wherein the optical pH sensor monitors pH levels ranging between 2 and 12.

7. A sensing system including an optical pH sensor used in harsh conditions, the optical pH sensor comprising:
a optical fiber; and
a calcined polymer coating contacting the optical fiber whereby the sensing system provides real-time monitoring of pH in high-pressure and high-temperature (HPHT) conditions.

8. The sensing system of claim 7, wherein the sensing system is a point sensor system.

9. The sensing system of claim 8, wherein the optical pH sensor communicates with at least two multi-mode fibers for transmission measurements.

10. The sensing system of claim 8, wherein the optical pH sensor communicates with at least one multi-mode fiber for reflection measurements.

11. The sensing system of claim 7, wherein the sensing system is a distributed sensing system.

12. The sensing system of claim 11, wherein the optical pH sensor communicates with at least one single-mode fiber, and is interrogated with an optical backscatter reflectometer.

13. The sensing system of claim 7, wherein the optical fiber is selected from the group consisting of unjacketed coreless optical fibers, unjacketed tapered multi-mode fibers, unjacketed single-mode fibers, and other evanescent field optical fibers.

14. The sensing system of claim 7, wherein the calcinated polymer coating is about 100 nm-3 μm thick.

15. A method of forming an optical fiber pH sensor, the method comprising:
applying a nitrogen-containing polymer solution to an optical fiber, forming a coated fiber; and
calcinating the coated fiber forming the optical fiber pH sensor.

16. The method of claim 15, wherein the nitrogen-containing polymer solution comprises a 10-30% by weight nitrogen-containing polymer in an organic solvent.

17. The method of claim 15, wherein the nitrogen-containing polymer solution comprises an organic polymer containing a nitrogen-based functional group, wherein the nitrogen-based functional group is selected from the group consisting of polymeric amines, polymeric amides, polyimides, and combinations thereof.

18. The method of claim 17, wherein polymeric amines are selected from the group consisting of polyethylenimine, polyaniline, and combinations thereof.

19. The method of claim 17, wherein the polymeric amides are selected from the group consisting of polyvinylpyrrolidone, nylon, and combinations thereof.

20. The method of claim 17, wherein the polyimides are selected from the group consisting of poly-(4,4′-oxydiphenylene), pyromellitimide, and combinations thereof.

21. The method of claim 17, wherein calcinating the coated, coreless fiber comprises thermally treating the coated fiber for about 2 hours at about 400-500° C.
